(19) United States
(12) Patent Application Publication
(10) Pub. No.: US 2018/0264860 A1
(43) Pub. Date: Sep. 20, 2018

(54) PRINTING APPARATUS

(71) Applicant: SEIKO EPSON CORPORATION, Tokyo (JP)

(72) Inventors: Masahiro KAMASAKI, Shiojiri (JP); Hideaki TAKAHASHI, Shiojiri (JP)

(21) Appl. No.: 15/917,366

(22) Filed: Mar. 9, 2018

(30) Foreign Application Priority Data
Mar. 16, 2017 (JP) 2017-050915

(51) Int. Cl. B41J 15/04

(52) U.S. Cl. CPC B41J 15/04

(57) ABSTRACT

A printing apparatus includes a housing, a platen disposed in the housing at a position where a medium is supported and recording is performed, an output port provided in the housing so that the medium is outputted through the output port, and a guiding section provided between the platen and the output port to guide the medium, wherein the guiding section includes a first guiding section facing one surface of the medium transported and a second guiding section facing the other surface of the medium, and the first guiding section and the second guiding section each include a bent portion.

### BACKGROUND

### 1. Technical Field

The present invention relates to printing apparatuses.

### 2. Related Art

Previously known printers include a platen roller that transports a receipt paper, a thermal printer head that performs printing on the transported receipt paper, a receipt cutter mechanism for cutting the printed receipt paper, and a receipt output port that outputs the cut receipt paper. JP-A-2005-67124 is an example of related art.

However, the above printers have a problem that the finger may easily touch the components inside the receipt cutter mechanism if it is inserted inside the printer through the receipt output port.

### SUMMARY

An advantage of some aspects of the invention can be implemented as the following aspects or application examples.

### Application Example 1

A printing apparatus according to the present application example includes a housing, a platen disposed in the housing at a position where a medium is supported and recording is performed, an output port provided in the housing so that the medium is outputted through the output port, and a guiding section provided between the platen and the output port to guide the medium, wherein the guiding section includes a first guiding section facing one surface of the medium transported and a second guiding section facing the other surface of the medium, and the first guiding section and the second guiding section each include a bent portion.

With this configuration, if the finger is inserted into inside the housing through the output port, the tip of the finger abuts the bent portion of the first guiding section and the second guiding section so that advancement of the finger into inside the housing is restricted. Accordingly, this configuration prevents the finger from touching the members such as a platen inside the housing, thereby improving the safety. Further, since the medium is transported along the bent portion from the platen to the output port, the medium can be reliably transported.

### Application Example 2

In the printing apparatus according to the above application example, wherein the first guiding section and the second guiding section each include a first bent portion and a second bent portion, and the first bent portion and the second bent portion are different in a bending direction.

With this configuration, since the first bent portion and the second bent portion are different in the bending direction, the first bent portion and the second bent portion can reliably prevent advancement of the finger inserted through the output port into inside the housing. Accordingly, the finger or the like can be prevented from touching the platen or the like.

### Application Example 3

In the printing apparatus according to the application example, either the first guiding section or the second guiding section is located on a line extended from a support surface of the platen.

With this configuration, since the first guiding section or the second guiding section is located on a line extended from a guiding surface of the platen, that is, a path from the output port to the platen is not straight, thereby preventing advancement of the finger inserted through the output port into inside the housing.

### Application Example 4

In the printing apparatus according to the above application example, the first guiding section is disposed under the second guiding section, the first bent portion is located at a position closest to the output port, and a radius of the first bent portion of the first guiding section is larger than a radius of the first bent portion of the second guiding section.

With this configuration, the finger inserted through the output port into inside the housing abuts the first bent portion of the first guiding section. However, since the radius of the first bent portion if relatively large, advancement of the finger into inside the housing is reliably restricted.

### Application Example 5

In the printing apparatus according to the above application example, a distance from the output port to the first bent portion is 30 mm or less.

With this configuration, when the first articulation of a V1 probe (safety standard IEC 62368-1) is inserted into the output port, the V1 probe abuts the first bent portion. Further, since the distance from the tip to the first articulation of the V1 probe is 30 mm, the first articulation cannot be bent in the housing when the tip of the V1 probe abuts the first bent portion. This prevents the V1 probe from being further inserted. That is, the safety standard can be met sufficiently, and advancement of the finger can be more reliably prevented. Further, the distance from the platen and the output port can be reduced, thereby reducing the size of the printing apparatus.

### Application Example 6

The printing apparatus according to the above application example further includes a movable member, wherein the movable member is disposed between the platen and the guiding section in a transport path of the medium.

With this configuration, the finger can be prevented from touching the movable member (for example, a cutter or a roller) even if the finger is inserted from the output port into inside the housing.

### BRIEF DESCRIPTION OF THE DRAWINGS

The invention will be described with reference to the accompanying drawings, wherein like numbers reference like elements.

FIG. 1 is a schematic perspective view which illustrates a configuration of a printing apparatus.

FIG. 2 is a schematic side cross-sectional view which illustrates a configuration of the printing apparatus.

FIG. 3 is a partial schematic side cross-sectional view which illustrates a configuration of the printing apparatus.

FIG. 4A is a schematic perspective view which illustrates a configuration of a second guiding section.

FIG. 4B is a schematic perspective view which illustrates another configuration of a second guiding section.

FIG. 5 is a partial schematic side cross-sectional view which illustrates the safety of the printing apparatus.

FIG. 6A is a schematic view which illustrates a printing method.

FIG. 6B is a schematic view which illustrates a printing method.

FIG. 7 is a partial schematic side cross-sectional view which illustrates a configuration of a printing apparatus according to modified example 1.

FIG. 8 is a partial schematic side cross-sectional view which illustrates a configuration of a printing apparatus according to modified example 2.

### DESCRIPTION OF EXEMPLARY EMBODIMENTS

With reference to the drawings, an embodiment of the present invention will be described. Throughout the drawings, components are shown at a scale different from the actual one in order to illustrate them at a recognizable size.

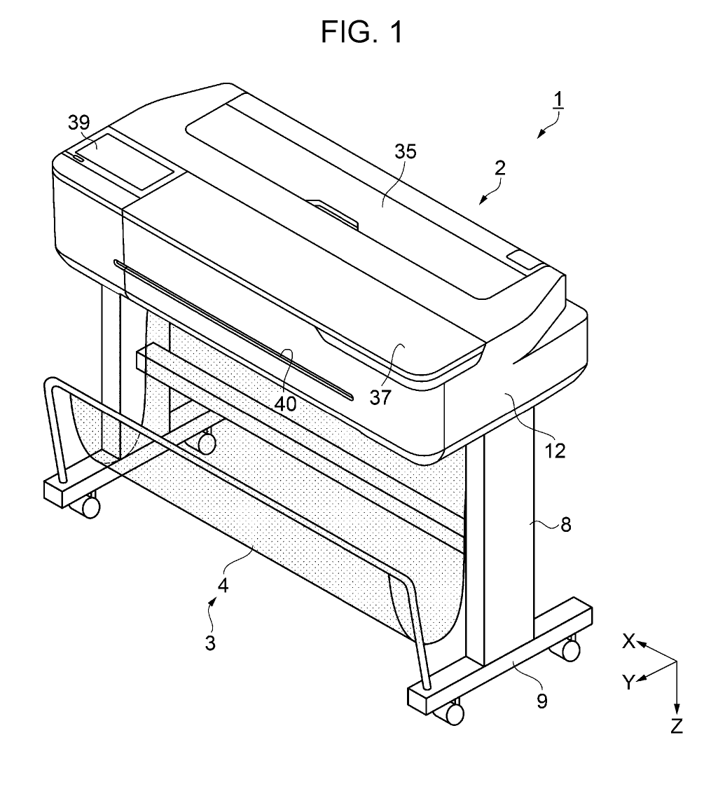

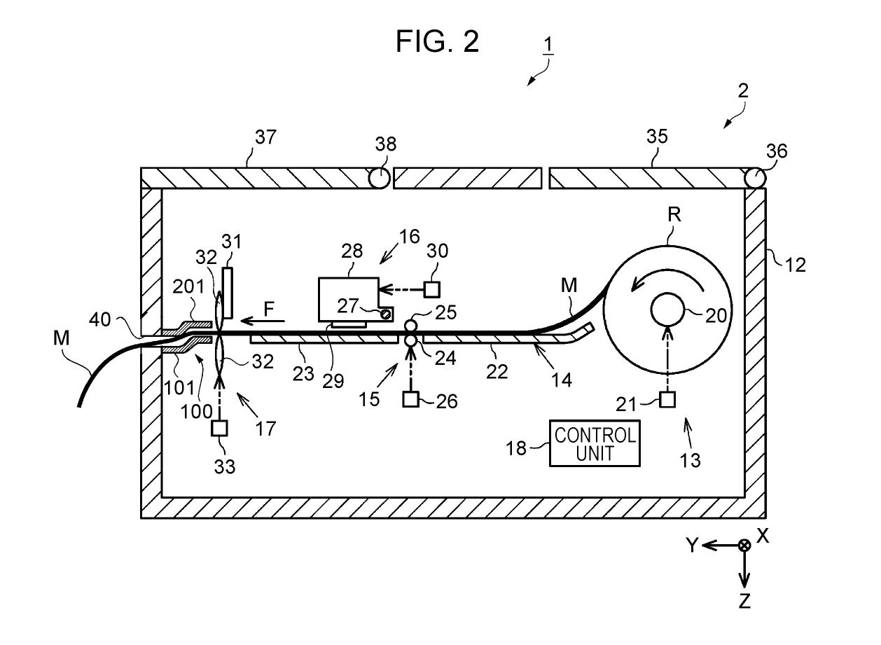

First, a configuration of a printing apparatus will be described. FIG. 1 is a schematic perspective view which illustrates a configuration of a printing apparatus, and FIG. 2 is a schematic side cross-sectional view which illustrates a configuration of the printing apparatus. As shown in FIGS. 1 and 2, the printing apparatus 1 is a large printer that can perform printing on a medium M (roll paper) of a relatively large size such as A0 and B0 of JIS standard. The printing apparatus 1 includes a main body 2 and an output sheet receiving section 3. The main body 2 is disposed on the top of posts 8 that stand on a base 9. A stacker 4 is disposed under the main body 2 so that the medium M outputted from the main body 2 is received in the stacker 4.

The main body 2 of the printing apparatus 1 includes a housing 12 of a cuboid shape, and the housing 12 houses a feeding section 13 for feeding out the medium M, a support section 14 that supports the medium M, a transport unit 15 for transporting the medium M, a printing section 16 for performing printing on the medium M, a cutting section (an example of a movable member) for cutting the medium M after printing (printed medium M), and a control unit 18 for controlling these components. Further, the housing 12 is provided with a guiding section 100 that guides the medium M.

In the description herein, the width direction of the printing apparatus 1 in which the medium M is cut is referred to as a “scan direction X,” a depth direction of the printing apparatus 1 is referred to as a “front-back direction Y,” a height direction of the printing apparatus 1 is referred to as a “vertical direction Z,” and a depth direction in which the medium M is transported is referred to as a “transport direction F.” The scan direction X, the front-back direction Y and the vertical direction Z are directions intersecting with (perpendicular to) each other, and the transport direction F is a direction intersecting with (perpendicular to) the scan direction X.

The feeding section 13 includes a holding shaft 20 that rotatably holds a roll R which is the rolled medium M, and a first rotation mechanism 21 that rotates the holding shaft 20. The holding shaft 20 extending in the scan direction X can hold various rolls R formed of different types of media M and the media M with different dimensions in the scan direction X (sizes in the width). The first rotation mechanism 21 is composed of, for example, a motor and a speed reducer. Further, the feeding section 13 is configured to rotate the roll R in one direction (in FIG. 2, counterclockwise direction) to thereby allow the medium M payed out from the roll R to be fed to the support section 14.

The support section 14 includes a first support section 22 that constitutes a transport path for the medium M from upstream to downstream in the transport direction, and a second support section 23 which serves as a platen. The first support section 22 guides the medium M fed out from the feeding section 13 toward the second support section 23. The second support section 23 is disposed at a position where printing (recording) of the medium M is performed, and serves to support the medium M to be printed and guide the medium M toward the cutting section 17 after printing.

The transport unit 15 includes a transport roller 24 that imparts a transportation force to the medium M, a driven roller 25 that presses the medium M against the transport roller 24, and a second rotation mechanism 26 that rotates the transport roller 24. The transport roller 24 and the driven roller 25 are rollers having an axis direction in the scan direction X.

The transport roller 24 is disposed vertically under the transport path for the medium M, and the driven roller 25 is disposed vertically above the transport path for the medium M. The second rotation mechanism 26 is composed of, for example, a motor and a speed reducer. Further, the transport unit 15 is configured to transport the medium M in the transport direction F by rotating the transport roller 24 while the medium M is nipped between the transport roller 24 and the driven roller 25.

The printing section 16 includes a guide shaft 27 extending in the scan direction X, a carriage 28 supported by the guide shaft 27 in a manner movable in the scan direction X, an ejection head 29 supported by the carriage 28 and having a plurality of nozzles (not shown in the figure) for ejecting ink onto the medium M, and a first movement mechanism 30 for moving the carriage 28 in the scan direction X.

The ejection head 29 is a so-called ink jet head having an actuator (not shown in the figure) such as a piezoelectric element for each of the nozzles (not shown in the figure) which is driven for ejecting ink from the nozzles. When the ejection head 29 is supported by the carriage 28, the openings of the nozzles face the second support section 23. Further, in the present embodiment, water-based ink is used as an ink.

The first movement mechanism 30 includes a motor and a speed reducer, and is configured to convert a rotation force of the motor into a force for moving the carriage 28 in the scan direction X. Accordingly, in the present embodiment, the first movement mechanism 30 is driven to cause the carriage 28 to reciprocate in the scan direction X while supporting the ejection head 29.

The cutting section 17 includes a guide member 31 extending in the scan direction X, a pair of rotary blades 32 that constitutes a cutter as an example of a movable body supported by the guide member 31 in a manner movable in the scan direction X, and a second movement mechanism 33 for moving the pair of rotary blades 32 in the scan direction X while rotating the rotary blades 32. The cutting section 17 is disposed between the second support section 23 of the transport path for the medium M and the guiding section 100, which will be described later.

The second movement mechanism 33 includes a motor and a speed reducer, and is configured to convert a rotation force of the motor into a force for rotating the pair of rotary blades 32 and a force for moving the pair of rotary blades 32 in the scan direction X. Accordingly, in the present embodiment, the second movement mechanism 33 is driven to cause the pair of rotary blades 32 to move in the scan direction X on both surfaces of the medium M to thereby cut the medium M by a predetermined length. Further, in the present embodiment, the moving direction of the pair of rotary blades 32 is consistent with the scan direction X.

An output port 40 is formed on a front wall of the housing 12 to penetrate the front wall in the front-back direction Y so that the medium M which has been printed by the printing section 16 and cut by the cutting section 17 in the housing 12 is outputted to the outside of the housing 12 through the output port 40. The output port 40 has a slit-shape extending in the scan direction X. Further, in the present embodiment, the second support section 23 is disposed at a position higher than the output port 40.

Further, the guiding section 100 is disposed between the second support section 23 and the output port 40 to guide the medium M. The guiding section 100 of the present embodiment is disposed between the cutting section 17 and the output port 40. The medium M which has been printed by printing section 16 is guided by the guiding section 100 to the output port 40. The detailed configuration of the guiding section 100 will be described later.

As shown in FIG. 2, a first openable cover 35 which is rotatable about a first shaft 36 is provided on the back side on the top of the housing 12 so that it can be opened when the roll R is set in the housing 12. Further, a second openable cover 37 which is rotatable about a second shaft 38 is provided on the front side on the top of the housing 12 so that it can be opened when a maintenance operation of the printing section 16 or the cutting section 17 in the housing 12 is performed. Moreover, an operation section 39 for performing various operations for the printing apparatus 1 is provided on the top of the housing 12 at a position adjacent to the second openable cover 37 in the scan direction X.

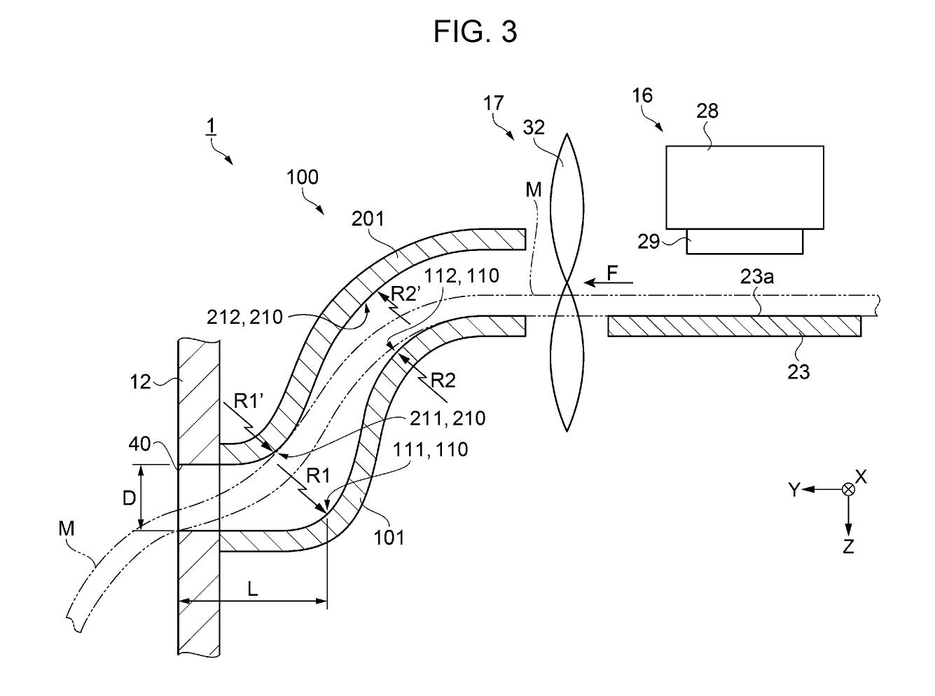

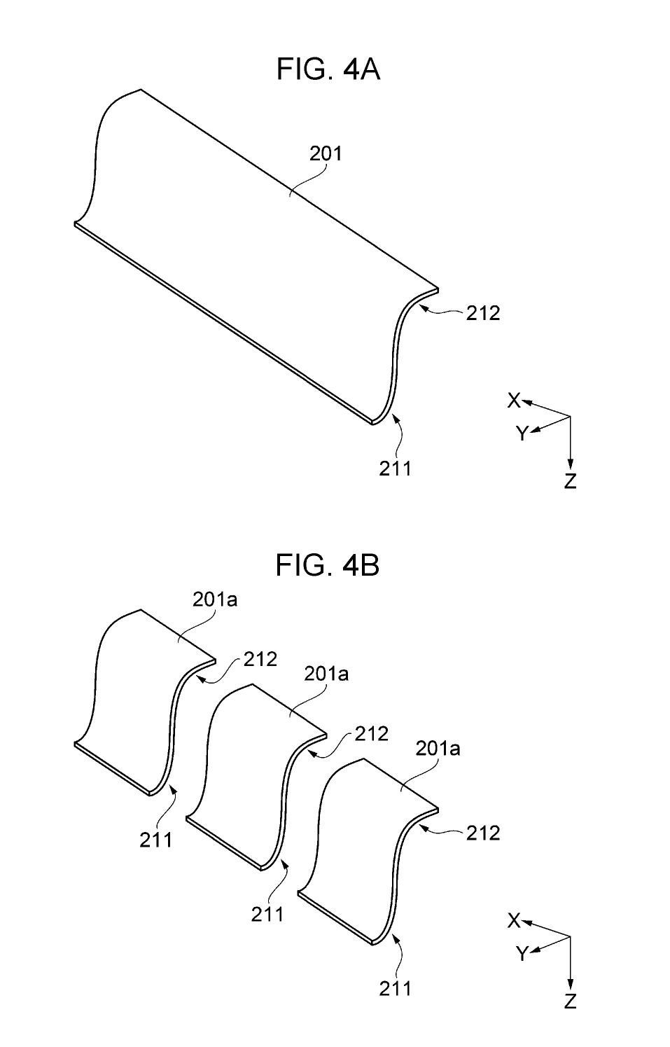

Next, the detailed configuration of the guiding section will be described. FIG. 3 is a partial schematic side cross-sectional view which illustrates the configuration of the printing apparatus. Specifically, FIG. 3 is a diagram which illustrates the configuration of the guiding section 100 and the peripherals. Further, FIG. 4A is a schematic perspective view which illustrates the configuration of a second guiding section, and FIG. 4B is a schematic perspective view which illustrates another configuration of a second guiding section.

As shown in FIG. 3, the guiding section 100 includes a first guiding section 101 which faces one of the surfaces of the medium M transported and a second guiding section 201 which faces the other of the surfaces of the medium M. In the present embodiment, the first guiding section 101 is disposed under the second guiding section 201.

Further, either the first guiding section 101 or the second guiding section 201 is located on a line extended from the support surface 23a that supports the medium M in the second support section 23. In the present embodiment, the second guiding section 201 is located on a line extended from the support surface 23a (in the Y direction) of the second support section 23. That is, a space does not extend in a straight line between the second support section 23 and the output port 40 and is regulated by either of the first guiding section 101 and the second guiding section 201.

The first guiding section 101 and the second guiding section 201 have bent portions 110 and 210, respectively. In other words, the first guiding section 101 and the second guiding section 201 each have a curved portion.

Further, the second guiding section 201 may be a single plate material extending in the X axis direction as shown in FIG. 4A, or second guiding sections 201a may be separate individual pieces as shown in FIG. 4B. Either of these can contribute to transportation of the medium M.

The bent portion 110 of the first guiding section 101 has a first bent portion 111 and a second bent portion 112. The first bent portion 111 is disposed at a position closest to the output port 40, and the second bent portion 112 is disposed at a position more spaced from the output port 40 than the first bent portion 111 is. In other words, the first bent portion 111 is disposed at a position closer to the second support section 23 than to the output port 40, and the second bent portion 112 is disposed at a position closer to the output port 40 than to the first bent portion 111. Further, the bent portion 210 of the second guiding section 201 has a first bent portion 211 and a second bent portion 212. The first bent portion 211 is disposed at a position closest to the output port 40, and the second bent portion 212 is disposed at a position more spaced from the output port 40 than the first bent portion 211 is. In other words, the first bent portion 211 is disposed at a position closer to the second support section 23 than to the output port 40, and the second bent portion 212 is disposed at a position closer to the output port 40 than to the first bent portion 211.

The first bent portion 111 and the second bent portion 112 of the first guiding section 101 are different in bending direction. That is, the first bent portion 111 has a curved surface having a radius of curvature R1, and the second bent portion 112 has a curved surface having a radius of curvature R2. A center point of the radius of curvature R1 is disposed at a position higher than the first bent portion 111, and a center point of the radius of curvature R2 is disposed at a position lower than the second bent portion 112. Similarly, the first bent portion 211 and the second bent portion 212 of the second guiding section 201 are different in bending direction. That is, the first bent portion 211 has a curved surface having a radius of curvature R1′, and the second bent portion 212 has a curved surface having a radius of curvature R2′. A center point of the radius of curvature R1′ is disposed at a position higher than the first bent portion 211, and a center point of the radius of curvature R2′ is disposed at a position higher than the second bent portion 212.

In the present embodiment, the curvature of the first bent portion 111 in the first guiding section 101 is larger than the curvature of the second bent portion 112. That is, the first bent portion 111 has a curve narrower than the second bent portion 112. Further, the curvature of the first bent portion 111 of the first guiding section 101 is larger than the first bent portion 211 of the second guiding section 201.

A distance L from the output port 40 (outer surface of the housing 12) to the first bent portion 111 is 30 mm or less. Further an opening width D (the dimension in the Z direction) of the output port 40 can be, for example, 5.8 mm or less.

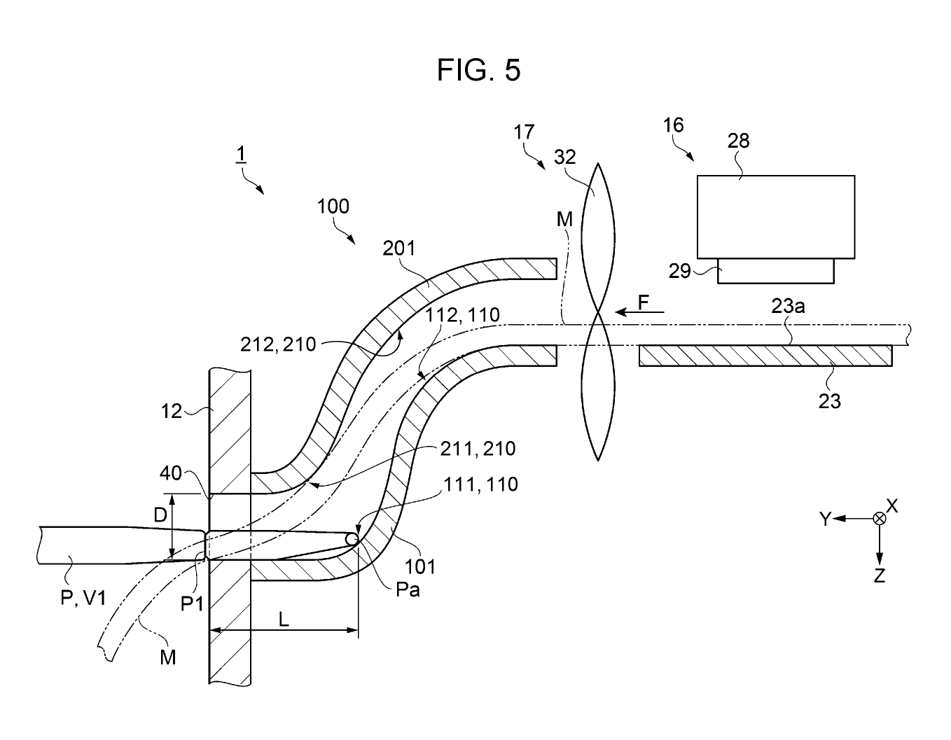

Next, the safety of the printing apparatus will be described. FIG. 5 is a schematic view which illustrates the safety of the printing apparatus. In the printing apparatus 1, a technical measure is taken against the insertion of a finger or the like from the output port 40 to the inside of the housing 12. In the case where the finger is inserted inside the housing 12 through the output port 40, the finger may touch the rotary blade 32 of the cutting section 17, which is a movable member, the ejection head 29, or the second support section 23, and the finger may be injured. Therefore, for example, for the device that cannot be restricted from being touched by children, it is required to conduct a test in compliance with the safety standard IEC 62368-1 using a V1 probe (a test probe imitating the human fingers) to ensure the safety.

FIG. 5 shows that a V1 probe P is inserted inside the housing 12 through the output port 40 of the printing apparatus 1 of the present embodiment. The V1 probe P includes a first articulation P1, and the length from a tip Pa of the V1 probe P to the first articulation P1 is 30 mm. In this case, as shown in FIG. 5, the tip Pa of the V1 probe P abuts the first bent portion 111 of the first guiding section 101, which is disposed at the distance L of 30 mm or less from the output port 40 (the outer surface of the housing 12), and is prohibited from being further advanced into the inside of the housing 12.

Further, since the first bent portion 111 and the second bent portion 112 are different in the bending direction, that is, since the bending directions of the first bent portion 111 and the second bent portion 112 are combined into the direction in which the finger articulation cannot be bent, advancement of the finger into inside the housing is restricted even if a thinner finger is inserted inside the housing 12 through the output port 40.

Further, since the second guiding section 201 is located on a line extended from the support surface 23a of the second support section 23 in the printing apparatus 1, the finger in a straight position cannot be advanced toward the second support section 23 from the output port 40. That is, advancement of the finger into inside the housing is restricted.

Further, since the radius of the first bent portion 111 of the first guiding section 101 is relatively large, the articulation of the finger inserted into the housing 12 through the output port 40 is prevented from being easily bent so that advancement of the finger into inside the housing is reliably restricted. Further, since the distance between the second support section 23 and the output port 40 can be reduced by increasing the radius of the first bent portion 111 of the first guiding section 101, the configuration of the printing apparatus 1 can be small-sized. Specifically, the dimension of the housing 12 in the Y direction can be reduced.

Next, a printing method will be described. In the present embodiment, a printing method by the above printing apparatus 1 will be described. In the printing method according to the present embodiment, the medium M is outputted from the second support section 23 via the guiding section 100 having the bent portion 210 to the outside through the output port 40. The detailed description follows.

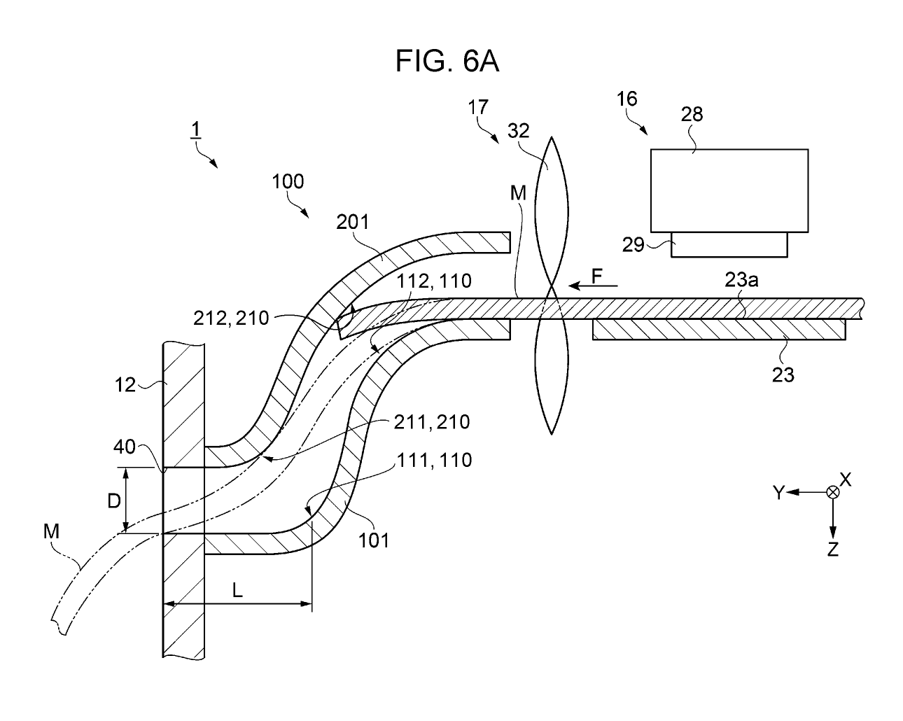

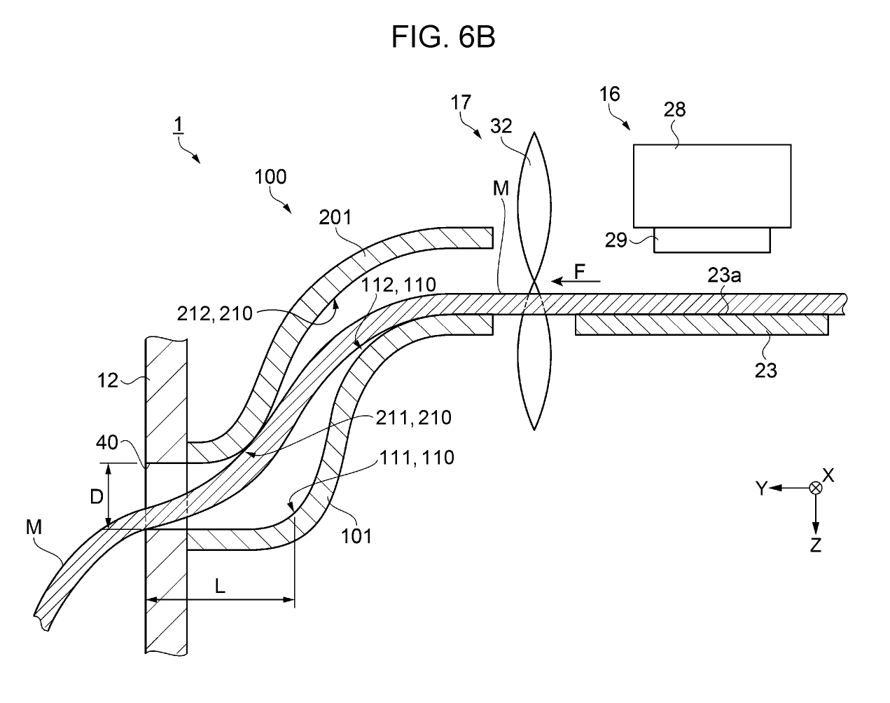

FIGS. 6A and 6B are schematic views which illustrate a printing method. As shown in FIG. 6A, the medium M printed by the printing section 16 is transported in the transport direction F. Accordingly, the leading end of the medium M on the downstream side in the transport direction F is downwardly transported along the second bent portion 212 of the second guiding section 201.

Then, as shown in FIG. 6B, the leading end of the medium M on the downstream side in the transport direction F is downwardly transported along the first bent portion 211 of the second guiding section 201, and the medium M is eventually outputted through the output port 40. Further, the medium M is cut by the cutting section 17 at a predetermined position, and the cut medium M is stored in the stacker 4 (see FIG. 1).

According to the aforementioned embodiment, the following effects can be obtained.

In the printing apparatus 1, if the finger is inserted into inside the housing 12 through the output port 40, the tip of the finger abuts the bent portion 110 of the guiding section 100 (specifically, the first bent portion 111) so that advancement of the finger into inside the housing is restricted. Accordingly, this configuration prevents the finger from touching the rotary blade 32 of the cutting section 17, the second support section 23, the ejection head 29, and the like, thereby improving the safety. Further, according to the configuration of the printing apparatus 1, a foreign substance as well as the finger can be prevented from being easily inserted into inside the housing 12 through the output port 40. Moreover, since the medium M is transported along the bent portion 210 (specifically, the first bent portion 211 and the second bent portion 212 of the second guiding section 201) from the second support section 23 to the output port 40, the medium M can be reliably transported.

Further, the present invention is not limited to the aforementioned embodiment, and various modification and alteration can be made to the above embodiment. Modified examples will be described below.

### Modified Example 1

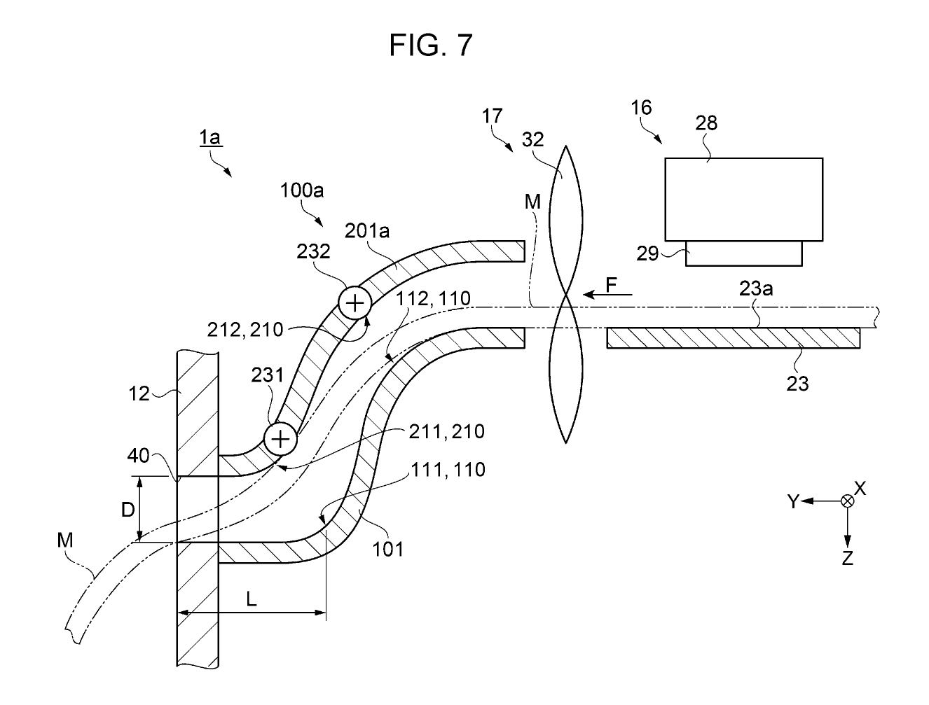

Although the guiding section 100 of the above embodiment is simply a surface for guiding the medium M, it is not limited to this configuration. For example, a rotary member can be added to the guiding section 100. FIG. 7 is a partial schematic side cross-sectional view which illustrates a configuration of a printing apparatus according to Modified example 1. As shown in FIG. 7, the guiding section 100a of the printing apparatus la includes rollers 231 and 232 as rotary members in the second guiding section 201a. Specifically, the roller 231 is disposed at a position corresponding to the first bent portion 211 of the second guiding section 201a and the roller 232 is disposed at a position corresponding to the second bent portion 212. Accordingly, the medium M can be more smoothly transported by the rollers 231 and 232. Further, in addition to the rollers 231 and 232, a rib can also be provided on the surface of the second guiding section 201a which faces the medium M. Specifically, a plurality of ribs extending from the cutting section 17 to the output port 40 are formed. In this configuration as well, the medium M can be more reliably transported. Further, the configuration other than the rollers 231 and 232 is the same as the configuration of the above printing apparatus 1, and the description thereof is omitted.

### Modified Example 2

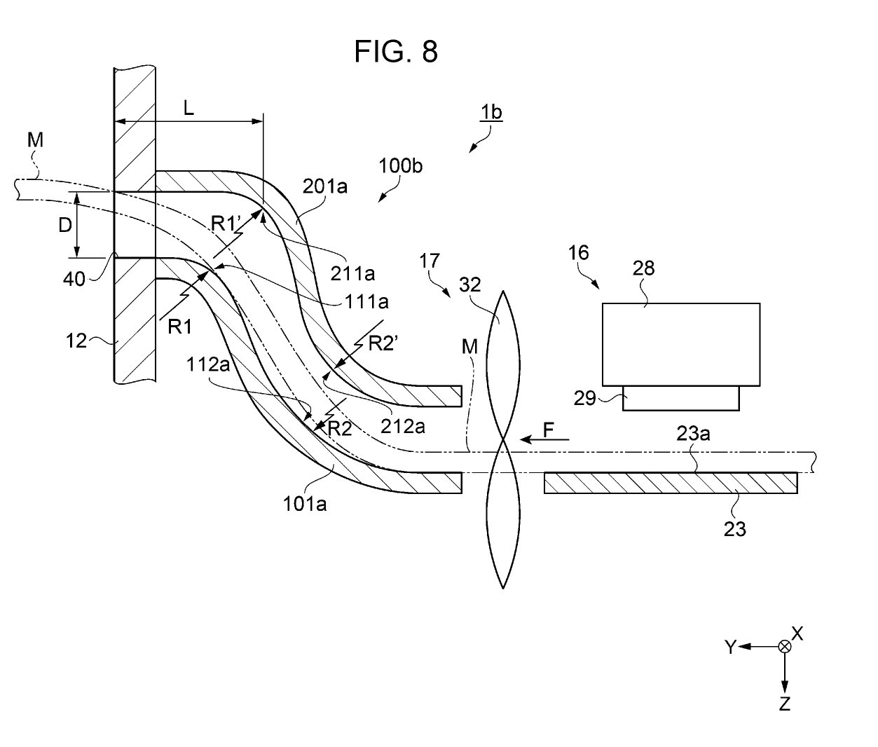

Although the second support section 23 of the present embodiment is disposed at a position higher than the output port 40, it is not limited thereto. FIG. 8 is a partial schematic side cross-sectional view which illustrates a configuration of a printing apparatus according to Modified example 2. As shown in FIG. 8, the printing apparatus 1b is configured such that the second support section 23 is located under the output port 40. A guiding section 100b is disposed between the second support section 23 and the output port 40 to guide the medium M. The guiding section 100b includes a first guiding section 101a and a second guiding section 201a disposed above the first guiding section 101a. The guiding section 100b has a shape of the guiding section 100 of the above embodiment which is turned upside down by 180 degrees.

The first guiding section 101a includes a first bent portion 111a and a second bent portion 112a. The first bent portion 111a is disposed at a position closest to the output port 40, and the second bent portion 112a is disposed at a position more spaced from the output port 40 than the first bent portion 111 is. The first bent portion 111a and the second bent portion 112a are different in the bending direction. Further, the second guiding section 201a includes a first bent portion 211a and a second bent portion 212a. The first bent portion 211a is disposed at a position closest to the output port 40, and the second bent portion 212a is disposed at a position more spaced from the output port 40 than the first bent portion 211a is. The first bent portion 211a and the second bent portion 212a are different in the bending direction. The first guiding section 101a is located on a line extended from the support surface 23a (in the Y direction) of the second support section 23. Further, the configuration other than the guiding section 100b is the same as the configuration of the above printing apparatus 1, and the description thereof is omitted. In this configuration as well, the advantageous effects similar to the above can be obtained.

This application claims priority under 35 U.S.C. § 119 to Japanese Patent Application No. 2017-050915, filed Mar. 16, 2017. The entire disclosure of Japanese Patent Application No. 2017-050915 is hereby incorporated herein by reference.

What is claimed is:

1. A printing apparatus comprising:
a housing;
a platen disposed in the housing at a position where a medium is supported and recording is performed;
an output port provided in the housing so that the medium is outputted through the output port; and
a guiding section provided between the platen and the output port to guide the medium, wherein
the guiding section includes a first guiding section facing one surface of the medium transported and a second guiding section facing the other surface of the medium, and
the first guiding section and the second guiding section each include a bent portion.

2. The printing apparatus according to claim 1, wherein the first guiding section and the second guiding section each include a first bent portion and a second bent portion, and the first bent portion and the second bent portion are different in a bending direction.

3. The printing apparatus according to claim 1, wherein either the first guiding section or the second guiding section is located on a line extended from a support surface of the platen.

4. The printing apparatus according to claim 2, wherein
the first guiding section is disposed under the second guiding section,
the first bent portion is located at a position closest to the output port, and
a radius of the first bent portion of the first guiding section is larger than a radius of the first bent portion of the second guiding section.

5. The printing apparatus according to claim 4, wherein a distance from the output port to the first bent portion is 30 mm or less.

6. The printing apparatus according to claim 1, further comprising a movable member, wherein the movable member is disposed between the platen and the guiding section in a transport path of the medium.
